(19) United States
(12) Patent Application Publication
(10) Pub. No.: US 2012/0116631 A1
(43) Pub. Date: May 10, 2012

(54) SCHEDULED VEHICLE MANAGEMENT SYSTEM AND METHOD

(75) Inventors: Bum Tae Lee, Goyang (KR); Chi Nam Oh, Suwon (KR); Min Suk Kim, Yongin (KR); Yun Joong Park, Seoul (KR); Young Eon Ma, Ulsan (KR)

(73) Assignees: KIA MOTORS CORPORATION, Seoul (KR); HYUNDAI MOTOR COMPANY, Seoul (KR)

(21) Appl. No.: 13/053,902

(22) Filed: Mar. 22, 2011

(30) Foreign Application Priority Data
Nov. 9, 2010 (KR) 10-2010-0111054

(51) Int. Cl. G06F 7/00

(52) U.S. Cl. 701/32.1

(57) ABSTRACT

A vehicle management system and method which analyze diagnostic trouble codes (DTCs) of the past having the same driver environment in order to predict the trouble probability for diagnostic target items in advance and provide the analyzed result to the driver so that the trouble and/or a car accident due to the trouble can be prevented.

### CROSS-REFERENCES TO RELATED APPLICATIONS

The priority of Korean patent application No. 10-2010-0111054 filed on Nov. 9, 2010, the disclosure of which is hereby incorporated in its entirety by reference, is claimed.

### BACKGROUND OF THE INVENTION

1. Field of the Invention

The present invention relates to a scheduled vehicle management system and method, and more particularly to a scheduled vehicle management system and method which regularly receive a diagnostic trouble code (DTC) of a vehicle from the telematics devices of the vehicles, cumulatively stores the DTC, and analyzes the cumulatively stored DTC to regularly provide information suitable to driver's characteristic.

2. Description of the Related Art

Recently, one of remarkable technologies is a telematics technology for a vehicle.

The telematics system for a vehicle is a system which combines a mobile communication technology, a location tracking technology and the Internet to detect a car accident, robbery, or the like, guide a driving route of a vehicle, and provide other various kinds of information and the like to a driver of the vehicle. That is, the telematics system for a vehicle is a system which provides various kinds of information to the vehicle based on mobile communication and a global positioning system (GPS).

Telematics allows the automobile industry and an information industry to be combined in order to create value-added services of a new concept capable of maximizing a synergy effect.

Thus, the telematics standardization group is established and the standardization group is performing standardization for operations and functions of components in the telematics system and services through communication protocols and communication networks between the components.

As the telematics technology is advancing and the telematics system is being developed, however, additional development for various services within the system are being demanded in order to satisfy the desires of users.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

Various aspects of the present invention have been made in view of the above problems, and provide vehicle management service which cumulative manages a diagnostic trouble code (DTC) to prevent a vehicle trouble in advance and to provide vehicle management service characterized by a user (driver).

According to an aspect of the present invention, a scheduled vehicle management system includes an analyzing unit, a comparison unit and a control unit. More specifically, the analyzing unit is configured to analyze DTCs which are regularly provided from telematics devices of vehicles based on a driver's environment in order to acquire trouble information related to the driver's environment. The comparison unit is configured to compare the trouble information associated with the driver's environment with current state information of a vehicle and outputs a comparison result. The control unit is configured to provide a diagnostic result based on the trouble information related to the driver's environment and the comparison result output by the comparison unit to a predesignated terminal and adjusts a DTC collection period of the vehicle accordingly.

The analyzing unit may also be configured to investigate a trouble history of the DTC data which has been cumulated for a fixed period of time according to the driver environment in order to check whether there is an item in which a trouble frequency is larger than a reference value among diagnostic target items and state information when the diagnostic target items are in a troubled state.

In some embodiments of the present invention, the analyzing unit may divide the DTC data which has been cumulated for the fixed period by the diagnostic target item and further divide the DTC divided by the diagnostic target item according to the driver's environment to investigate the trouble history.

The comparison unit may also be configured to compare the state information when troubled with current state information of the vehicle. In doing so, the control unit determines whether there is an item in which trouble probability is larger than a reference value among the diagnostic target items using a comparison result of the comparison unit. At this time, the control unit may adjust the DTC collection period for the item in which the trouble frequency or the trouble probability is larger than the reference value to be shorter. If there is the case where the items in which the trouble probability is larger than the reference value, the control unit provides information for a current state of the corresponding item, trouble response procedure and an after-sales service (A/S) center to the terminal

If the DTC is not received from the telematics device during a predetermined period, the control unit may transmit a DTC collection request signal to the corresponding telematics device. In other embodiments of the present invention, the control unit may regularly transmit a DTC collection request signal to the telematics device and regularly receive the DTC from the telematics device.

According to an aspect of the present invention, a scheduled vehicle management method includes regularly receiving a diagnostic trouble codes (DTCs) from telematics devices of vehicles and cumulatively storing the DTCs. The method then analyzes the DTCs cumulatively stored according to a driver's environment in order to acquire trouble information about the driver's environment. Once analyzed, the trouble information about the driver's environment is compared with current state information of a vehicle in order to acquire information related to a trouble probability of the vehicle and provides a diagnostic result to a predesignated terminal based on the trouble information about the driver's environment and the information related to the trouble probability. The predesignated terminal then adjusts a DTC collection period of the vehicle accordingly.

More particularly, analyzing the DTCs cumulatively stored may also include investigating the trouble history of the DTC cumulated for a fixed period of time according to the driver's environment to check an item in which a trouble frequency is larger than a reference value among diagnostic target items and state information when the diagnostic target items are troubled.

The analyzing the DTC cumulatively stored may also include dividing the DTC by the diagnostic target items, and further dividing the DTC divided by the diagnostic target item by the driver's environment to investigate the trouble history.

In some embodiments of the present invention, comparing the trouble information when troubled with current state information of the vehicle may include comparing state information when troubled with the current state information of vehicle in order to determine whether there is an item in which trouble probability is larger than a reference value, or not.

Additionally, providing a diagnostic result may include adjusting the DTC collection period to be shorter when the item in which the trouble frequency or the trouble probability is larger than the reference value.

Providing a diagnostic result may also include providing information for a current status of the corresponding item, a trouble response procedure and an A/S center to the terminal if there is an item in which the trouble probability is larger than the reference value.

Finally, in some embodiments of the present invention, receiving the DTCs may include, if the DTCs are not received at a fixed time period from the telematics devices, transmitting a DTC collection request signal to a corresponding telematics device, or regularly transmitting the DTC collection signal to the telematics devices and regularly receiving the DTCs from the telematics devices.

### BRIEF DESCRIPTION OF THE DRAWINGS

The objects, features and advantages of the present invention will be more apparent from the following detailed description in conjunction with the accompanying drawings, in which:

FIG. 1 is a configuration block diagram illustrating the whole configuration of an exemplary vehicle management system according to an exemplary embodiment of the present invention.

FIG. 2 is a configuration block diagram detailedly illustrating a configuration of an exemplary vehicle management server according to an exemplary embodiment of the present invention.

FIG. 3 is a flowchart illustrating a vehicle management method according to an exemplary embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

Generally, the present invention provides a scheduled vehicle management system which includes management server which utilizes a control unit, an analyzing unit and a comparison unit. More specifically, the control unit is configured to provide diagnostic results and comparison results wirelessly to a predesignated terminal. The analyzing unit is configured to analyze diagnostic trouble codes (DTCs) at regular intervals that are provided from devices of vehicles and are based on a driving environment in order to acquire information about the driving environment of a vehicle. The comparison unit is configured to compare the information about the driver environment with current state information of a vehicle and output the comparison results.

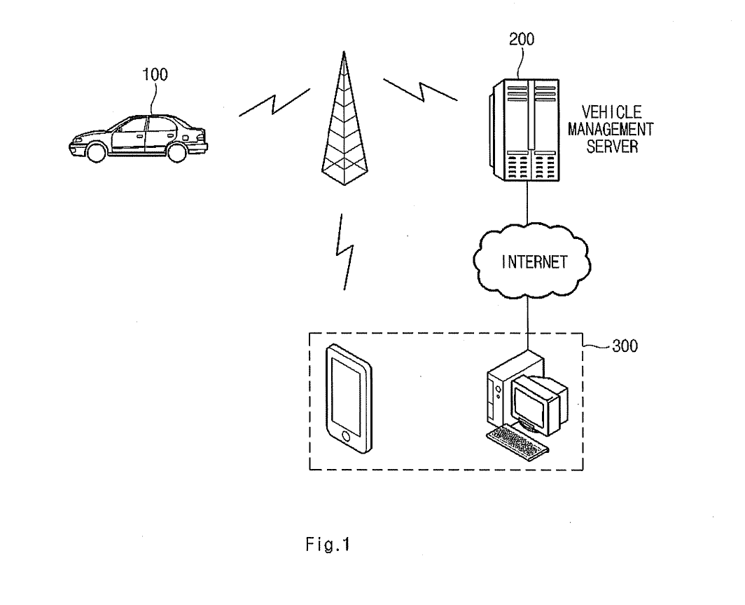

FIG. 1 is a configuration block illustrating the whole configuration of a vehicle management system according to an exemplary embodiment of the present invention.

As shown in FIG. 1, a system includes a telematics device 100 of a vehicle, a vehicle management server 200, and a user terminal 300.

The telematics device 100 measures a state of vehicle on the regular basis or according to the vehicle management server 200 in order to generate a diagnostic trouble code (DTC) and transmits the DTC to the vehicle management server 200 though a wireless communication network such as wireless fidelity (WIFI), wireless broadband (WIBRO), code division multiple access (CDMA), wideband code division multiple access (WCDMA), global system/standard for mobile communication (GSM). That is, the telematics device 100 voluntarily collects the DTC during every preset time period and transmits the collected DTC to the vehicle management server 200. Additionally the telematics device may also collect the DTC by a DTC collection request signal from the vehicle management server 200 and transmit the collected DTC to the vehicle management server 200. At this time, the DTC collection request signal may be transmitted from the vehicle management server 200 to the telematics device 100 if the telematics device 100 does not transmit the DTC at a fixed period of time (for example, if the telematics device 100 is in a sleep mode). Thus, a DTC collection period of the telematics device 100 may be remotely controlled by the vehicle management server 200.

The vehicle management server 200 is configured to store the DTC regularly provided from the telematics device 100, analyze the DTC, and regularly notify the user terminal 300 or the telematics device 100 of the diagnostic result. More specifically, the vehicle management server 200 cumulatively stores the DTC provided from the telematics device 100, analyzes the cumulatively stored DTC according to a driver's environment, and provides customized vehicle management information to the driver via a display on, e.g., a personal computer or mobile device.

For example, the vehicle management server 200 divides the DTC collected from the telematics device 100 of the respective vehicles according to the driver's environment (e.g., a kind of a vehicle, driver's age and gender, an area in which the vehicle is frequently operated, climate of the corresponding area, and the like) to analyze the trouble history (statistic value) and investigates trouble information related to the driver's environment (e.g., information for elements (e.g., parts) in which a trouble frequency is larger than a reference value and state information when troubled) based on the analyzed trouble history. The vehicle management server 200 compares the trouble information related to the driver's environment with current state information of a vehicle to determine trouble probability for the corresponding vehicle. If the trouble probability is larger then a reference value, the vehicle management server provides the diagnostic result to the driver terminal 300 and/or the predesignated after-sales service (A/S) center (not shown). At this time, the information transmitted to the user/driver terminal 300 may include information relating to a current state and a trouble estimated time point for the device which have the trouble probability, a trouble response procedure, and the A/S center. Furthermore, if there is a device of which the trouble probability is larger than a constant level, the vehicle management server 200 makes the DTC collection period for the corresponding device shorter so that it is possible to perform more intensive diagnosis for the corresponding device due to its likelihood of failure or trouble.

The user terminal 300 is a terminal of a driver (service subscriber) and receives the diagnostic result for the vehicle from the vehicle management server 200 and displays the diagnostic result on a screen or display. The user terminal 300 may include for example a smart phone, a personal computer (PC), a personal digital assistant (PDA), a portable multimedia player (PMP), and the like which is communicable with the vehicle management server 200 through a wired or wireless communication network such as world wide web (WEB), WIBRO, WIFI, radio frequency (RF) communication, and the like.

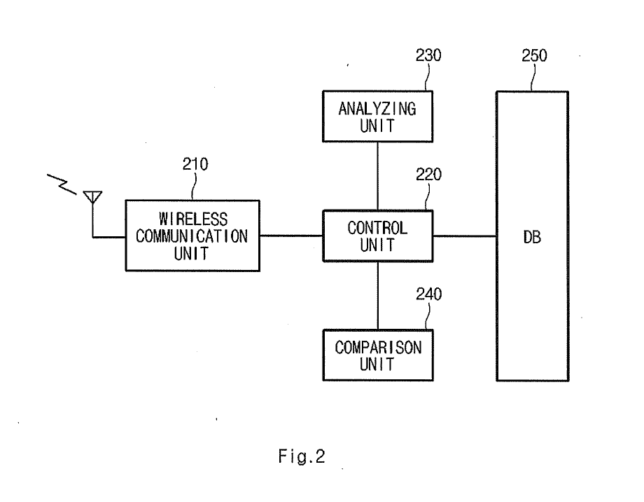

FIG. 2 is a construction diagram detailedly illustrating the exemplary configuration of the vehicle management server 200 of FIG. 1.

The vehicle management server 200 includes a wireless communication unit 210, a control unit 220, an analyzing unit 230, a comparison unit 240 and a database 250.

The wireless communication unit 210 transmits/receives data to/from the telematics device 100 or the user terminal 300 according to the predefined communication protocol. The wireless communication unit 210 may transmit and receive the data through a wireless communication technology such as a mobile communication technology (CDMA, WCDMA, or the like) or a wireless internet technology (WIBRO).

The control unit 220 controls the overall operation of the vehicle management server 200 and stores the DTC received from the telematics device 100 through the wireless communication unit 210 with matching driver information in the database 250. If the DTC is not normally received from the telematics device 100 during a fixed period of time, the control unit 220 may generate a DTC collection request signal and transmit the DTC collection request signal to the corresponding telematics device 100. The control unit 220 may regularly generate the DTC collection request signal and transmit the DTC collection request signal to the telematics device 100 to regularly collect the DTC from the telematics device 100. The control unit 220 regularly notifies the driver of the diagnostic result for the vehicle. At this time, when there is an item having a high trouble frequency or an item having high trouble probability among the diagnostic target items, the control unit 220 may selectively adjust the DTC collection period for the corresponding item so as to intensively manage the corresponding item. The control unit 220 may also notify the driver and/or the predesignated A/S center of the information relating to the item having the trouble probability in advance so as to maintain the vehicle efficiently.

The analyzing unit 230 analyzes a trouble history (statistic value) according to a driver environment using the DTC cumulatively stored in the database. For example, the analyzing unit 230 divides the DTC cumulatively stored for a fixed period of time by a diagnostic target item and further divides the DTC divided by the item according to the driver environment (e.g., a kind of a vehicle, driver's age and gender, an area in which the vehicle is frequently operated, climate of the corresponding area, and the like) to investigate the trouble history. Thus, the analyzing unit 230 finds out trouble information relating to the driver's environment which may include information for which an item statistically has the highest trouble frequency in relation to the driver's environment or situation information for which a related vehicle situation in which a corresponding item is in trouble and stores the trouble information by the driver environment in the database 250.

The comparison unit 240 compares the trouble information relating to the driver's environment analyzed in the analyzing unit 230 with current state information of a vehicle to investigate trouble probability of each vehicle. That is, the comparison unit 240 identifies trouble information corresponding to a driver environment using a comparison target vehicle from the trouble information related the driver's environment according to instruction from the control unit 220. The comparison unit also compares the trouble information corresponding to a driver's environment of a comparison target vehicle with current state information of the comparison target vehicle to investigate trouble probability of the corresponding vehicle, and transfer the comparison result to the control unit 220.

The database 250 is configured to store the driver information, the DTC received from the telematics device 100, the trouble information by the driver environment, and the like.

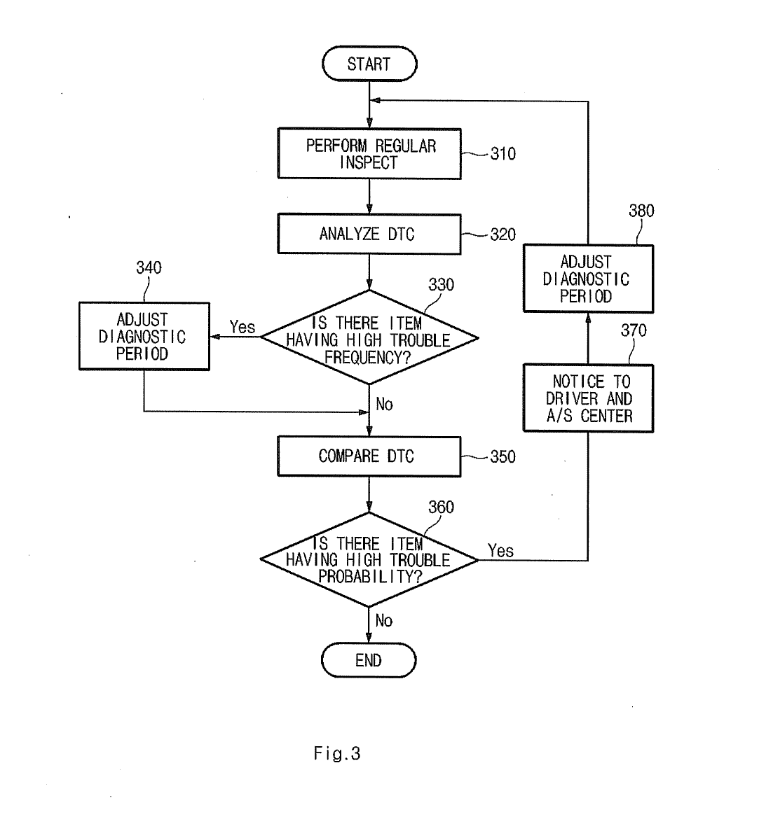

FIG. 3 is a flowchart illustrating a vehicle management method according to the present invention.

First, the telematics devices 100 of vehicles which are subscribers to the service according to the present invention regularly check the state of vehicle at fixed periods of time, collect a DTC, and transmit the collected DTC to the vehicle management server 200 through a wireless communication network (CDMA, WCDMA, GSM, WIFI, WIBRO, Bluetooth, or the like) (S310).

The DTC may include, for example, oil temperature, transmission fluid temperature, outside temperature, battery voltage, pressure within a gas tank, state of a gear, speed of an engine, or the like)

The control unit 220 cumulates based on the time in which it was collected and stores the DTC received from the wireless communication unit 210 with matching driver information for a corresponding driver in the database 250. The driver information may include for example, a kind of a vehicle, driver's age and gender, an area in which the vehicle is frequently operated, climate of the corresponding area, and the like.

If the DTC is not received at a fixed time period, the control unit 220 may transmit a DTC collection request signal to a corresponding telematics device 100. For example, when the telematics device 100 enters in a sleep mode, the telematics device 100 can not collect and transmit the DTC. In this instance, the control unit 220 would transmit the DTC collection request signal to the telematics device 100 so that the telematics device 100 would be woken up to collect and transmit the DTC accordingly.

The analyzing unit 230 analyzes a trouble history (statistic value) according to the driver environment using the cumulatively stored DTC in response to more than a constant or predetermined amount of the DTC being cumulated (S320).

For example, the analyzing unit 230 divides the DTC cumulatively stored for a fixed period of time by an item and further divides the DTC divided by the item according to the driver environment (e.g., the kind of a vehicle, driver's age and gender, an area in which the vehicle is frequently operated, climate of the corresponding area, and the like) to investigate the trouble history. That is, even when analyzing the same kind of parts, the time point in which the corresponding part fails may be different from each other according to a kind of vehicle in which the parts are used in, a driver's propensity, and the regional character.

Accordingly, the analyzing unit 230 analyzes DTC of the past having the same driving environment to collect trouble information related the driver's environment including information for which a diagnostic target item that is more frequently troubled or failed than the reference value in the driver environment or state information for which state of a corresponding item is in trouble of the vehicle. If the analysis is completed, the analyzing unit 230 stores the trouble information related to the driver's or driving environment in the database 250 and notifies the control unit 220 of the analyzed result.

When there is an item having a high frequency of trouble information relating to the driver's environment, the control unit 220 generates a control signal for adjusting a DTC collection period of the vehicle for the corresponding item (S340).

The comparison unit 240 compares the current state information of a comparison target vehicle with the previously analyzed trouble information relating to the driver's environment according to instructions from the control unit 220 and transmits the comparison result to the control unit 220 (S350) to be sent to the user.

For example, the comparison unit 240 compares state information relating to when the trouble occurs in the same environment as (or in the similar to) a current driver/driving environment for the respective vehicle with state information of a DTC newly received and transfers the comparison result to the control unit 220. That is, the comparison unit 240 transfers information about how close the current state of a vehicle associated with the item is to trouble probability.

If there is an item in which the trouble probability is larger than the preset reference value based on the information from the comparison unit 240 (S350), the control unit 220 transmits the related information (e.g., the information for current state of a corresponding item and a trouble estimated time point, a response procedure, and an A/S center) to the driver terminal 300 and the predesignated A/S center (S370).

That is, if the control unit 220 notifies the driver when the vehicle is not actually troubled, but the vehicle is likely to be troubled based on the information from the comparison unit 240, the control unit 240 notifies the driver of the situation in advance so that the trouble can be prevented accordingly.

The control unit 220 generates a control signal for adjusting the DTC collection period of the vehicle for the item having high trouble probability and transmits the control signal to the telematics device 100 of a corresponding vehicle (S380).

That is, since the corresponding item has a higher likelihood of trouble or failure in comparison to other items in the vehicle, the control unit 220 generates a control signal for making the DTC collection period for the corresponding item shorter than the previous collection period.

For example, the embodiment as described above illustrates that the DTC collection request signal is generated when the telematics device 100 does not transmit the DTC at the fixed period of time. However, the vehicle management server 200 regularly generates a DTC collection request signal and transmits the DTC collection request signal to the telematics device 100 so that the vehicle management server 200 can regularly receive the DTC from the telematics device 100 using the DTC collection request signal.

In this case, in S340 and S380, the control unit 220 can adjust the generation period of the DTC collection request signal without generating a control signal for controlling a diagnostic period of the telematics device 100.

In addition, for convenience of description, the embodiment as described above illustrates that the analyzing unit 230 and the comparison unit 240 are separately configured, but functions of the analyzing unit 230 and the comparison unit 240 may be performed as one configuration element, for example, the control unit 220.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A scheduled vehicle management system, the system comprising:
an analyzing unit which analyzes diagnostic trouble codes (DTCs) regularly provided from telematics devices of vehicles based on a driver environment to acquire trouble information by the driver environment;
a comparison unit which compares the trouble information by the driver environment with current state information of a vehicle and outputs a comparison result; and
a control unit which provides a diagnostic result based on the trouble information by the driver environment and the comparison result of the comparison unit to a predesignated terminal and adjusts a DTC collection period of the vehicle.

2. The system according to claim 1, wherein the analyzing unit investigates a trouble history of the DTC cumulated for a fixed period according to the driver environment to check whether there is an item in which a trouble frequency is larger than a reference value among diagnostic target items and state information when the diagnostic target items are troubled.

3. The system according to claim 2, wherein the analyzing unit divides the DTC cumulated for the fixed period by the diagnostic target item and further divides the DTC divided by the diagnostic target item according to the driver environment to investigate the trouble history.

4. The system according to claim 2, wherein the comparison unit compares the state information when troubled with current state information of the vehicle.

5. The system according to claim 4, wherein the control unit determines whether there is an item in which trouble probability is larger than a reference value among the diagnostic target items using a comparison result of the comparison unit.

6. The system according to claim 5, wherein the control unit adjusts the DTC collection period for the item in which the trouble frequency or the trouble probability is larger than the reference value to be shorter.

7. The system according to claim 5, wherein if there is the case where the items in which the trouble probability is larger than the reference value, the control unit provides information for a current state of the corresponding item, a trouble response procedure and an after-sales service (A/S) center to the terminal.

8. The system according to claim 1, wherein if the DTCs are not received from the telematics devices at a predetermined period, the control unit transmits a DTC collection request signal to the corresponding telematics device.

9. The system according to claim 1, wherein the control unit regularly transmits a DTC collection request signal to the telematics devices and regularly receives the DTCs from the telematics devices.

10. A scheduled vehicle management method, the method comprising:
receiving regularly a diagnostic trouble codes (DTCs) from telematics devices of vehicles and cumulatively storing the DTCs;
analyzing the DTCs cumulatively stored according to a driver environment to acquire trouble information by the driver environment;
comparing the trouble information by the driver environment with current state information of a vehicle to acquire information for trouble probability of the vehicle; and
providing a diagnostic result based on the trouble information by the driver environment and the information for the trouble probability to a predesignated terminal and adjusting a DTC collection period of the vehicle.

11. The method according to claim 10, wherein the analyzing the DTCs cumulatively stored includes investigating the trouble history of the DTC cumulated for a fixed period according to the driver environment to check an item in which a trouble frequency is larger than a reference value among diagnostic target items and state information when the diagnostic target items are troubled.

12. The method according to claim 11, wherein the analyzing the DTC cumulatively stored includes dividing the DTC by the diagnostic target item, further dividing the DTC divided by the diagnostic target item by the driver environment to investigate the trouble history.

13. The method according to claim 11, wherein the comparing the trouble information with current status information of the vehicle includes comparing state information when troubled with the current state information of vehicle to determine whether there is an item in which trouble probability is larger than a reference value, or not.

14. The method according to claim 13, wherein the providing a diagnostic result includes adjusting the DTC collection period to be shorter in the case of the item in which the trouble frequency or the trouble probability is larger than the reference value.

15. The method according to claim 13, wherein the providing a diagnostic result includes providing information for a current status of the corresponding item, a trouble response procedure and an A/S center to the terminal if there is an item in which the trouble probability is larger than the reference value.

16. The method according to claim 10, wherein the regularly receiving the DTCs includes transmitting a DTC collection request signal to a corresponding telematics device if the DTCs are not received at a fixed period from the telematics devices.

17. The method according to claim 10, wherein the regularly receiving the DTCs includes regularly transmitting a DTC collection signal to the telematics devices and regularly receiving the DTCs from the telematics devices.

18. A scheduled vehicle management system, the system comprising:
a control unit on a server configured to provide diagnostic results and comparison results wirelessly to a predesignated terminal, the control unit further including
an analyzing unit configured to analyze diagnostic trouble codes (DTCs) at regular intervals that are provided from devices of vehicles and are based on a driving environment in order to acquire information about the driving environment of a vehicle, and
a comparison unit configured to compare the information about the driver environment with current state information of a vehicle and output the comparison results.
